(19) United States
(12) Patent Application Publication
(10) Pub. No.: US 2004/0254863 A1
(43) Pub. Date: Dec. 16, 2004

(54) Asset maintaining, controlling and accessing program

(76) Inventors: Douglas L. Jones, Phoenix, AZ (US); James G. Simmons, Tempe, AZ (US)

Correspondence Address: ROBERT A. PARSONS, 340 E. PALM LN, SUITE 260, PHOENIX, AZ, 85004, US

(21) Appl. No.: 10/226,991

(22) Filed: Aug. 23, 2002

Related U.S. Application Data
(63) Continuation of application No. 09/432,553, filed on Nov. 3, 1999, now abandoned.

(51) Int. Cl. G06F 17/60

(52) U.S. Cl. 705/29

(57) ABSTRACT

An asset maintaining, controlling and accessing program includes software instructions for controlling a computer with a display to provide a graphical user interface including drag and drop features, point-and-click access to user and system functions, and drop-down menus. The Program validates log-on and includes encrypted passwords and multiple levels of customizable security for controlling user access to sensitive data and instructions. A plurality of repositories are included and each is connected to store different asset information. Software instructions perform a plurality of user functions including transferring assets from one of the plurality of repositories to another of the plurality of repositories so that the program controlling the computer display provides selected information stored in the plurality of repositories to a user and stores the information in a directed repository.

### FIELD OF THE INVENTION

This invention relates to a computer program for managing assets in an organization.

More particularly, the present invention relates to apparatus and methods of maintaining, controlling and accessing asset information within a computer system.

### BACKGROUND OF THE INVENTION

In large organizations, such as large companies and the like, it is very difficult to manage all of the various assets which are used, sold, or transferred between departments, and which may also include purchased items, lease/rental/consignment equipment, etc. The manger must have information such as the number or lot of each piece of equipment as well as the physical position (e.g. active, storage, etc.) of the equipment. Further, information as to the origin of the assets or equipment and any information as to maintenance, components, etc. is desirable. Generally, this variety of information and functions requires a number of people or managers who must coordinate their activities closely. Even with relatively close coordination and cooperation the managing functions overlap to produce redundant activities or may leave voids in which certain functions are lacking.

It would be highly advantageous, therefore, to remedy the foregoing and other deficiencies inherent in the prior art.

Accordingly, it is an object of the present invention to provide a new and improved computer program for maintaining, controlling and accessing assets.

Another object of the invention is to provide a new and improved computer program which is easy to use.

And another object of the invention is to provide a new and improved computer program which is highly accessible at all times.

Still another object of the present invention is to provide a new and improved computer program which receives and stores information on all assets.

Yet another object of the invention is to provide a new and improved computer program which greatly simplifies the task of managing assets and which substantially improves asset costs.

A further object of the invention is to provide a new and improved computer program which is capable of tracking all assets and generating any paper work (e.g. invoices, purchase orders, identifying barcodes, etc.) that may be necessary in the business.

And a further object of the invention is asset tracking from date of purchase to sale of asset as it is surplused and sold.

Yet a further object of the invention is asset tracking of consignment, lease, rental, security, surplus, active and expense items under one domain for control.

### SUMMARY OF THE INVENTION

Briefly, to achieve the desired objects of the instant invention in accordance with a preferred embodiment thereof, provided is an asset maintaining, controlling and accessing program including software instructions for controlling a computer with a display to provide a graphical user interface including drag and drop features, point-and-click access to user and system functions, drop-down menus, and a user definable toolbar. Validated log-on, encrypted passwords and multiple levels of customizable security are included to control user access to sensitive data and instructions. A plurality of repositories are provided, such as active, surplus, and sales records, and each repository is connected to store different asset information. Software instructions for performing a plurality of user functions are also provided, including receiving assets, finding asset information stored in the plurality of repositories, managing assets, and providing reports.

Briefly, a major advantage of the novel asset maintaining, controlling and accessing program is the ability to include all information about each asset in the repositories and to quickly and easily shift the asset between repositories without the need for re-identifying or re-defining the asset.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a flow/block diagram of an asset maintaining, controlling and accessing program in accordance with the present invention and illustrating the interconnection and/or cooperation of the various components;

FIGS. 2 and 3 illustrate a Security Configuration screens for different levels of security in the asset maintaining, controlling and accessing program of FIG. 1;

FIG. 4 illustrates a main screen of the display for the asset maintaining, controlling and accessing program of FIG. 1;

FIG. 5 illustrates a Record Manager screen for the asset maintaining, controlling and accessing program of FIG. 1;

FIG. 6 illustrates a Query Manager screen for the asset maintaining, controlling and accessing program of FIG. 1;

FIG. 7 illustrates a Sales Manager screen for the asset maintaining, controlling and accessing program of FIG. 1;

FIG. 8 illustrates a Contact Manager screen for the asset maintaining, controlling and accessing program of FIG. 1;

FIG. 9 illustrates an Invoice Manager screen for the asset maintaining, controlling and accessing program of FIG. 1;

FIG. 10 illustrates a Data Import/Export screen for the asset maintaining, controlling and accessing program of FIG. 1;

FIG. 11 illustrates a Purchase Order screen for the asset maintaining, controlling and accessing program of FIG. 1;

FIG. 12 illustrates an Inter-Company Transfer screen for the asset maintaining, controlling and accessing program of FIG. 1; and

FIG. 13 illustrates a Lease/Rental screen for the asset maintaining, controlling and accessing program of FIG. 1.

### DETAILED DESCRIPTION OF THE PREFERRED EMBODIMENT

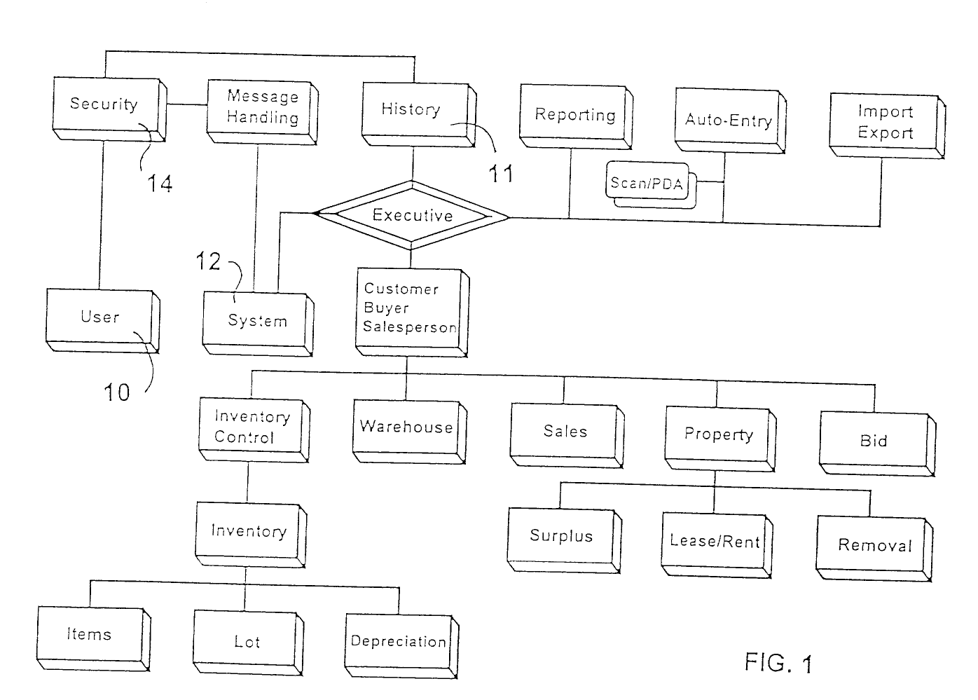

Turning now to the drawings in which like reference characters indicate corresponding elements throughout the several views, attention is first directed to FIG. 1 which illustrates a flow/block diagram of an asset maintaining, controlling and accessing program (hereinafter referred to as the Program) in accordance with the present invention. In this preferred embodiment, the Program is a Windows 95/98. Windows NT 3.51 or 4.0, and Windows 2000 based multimedia, client-server product. Generally, the Program is provided in standalone, network, and enterprise versions in CD formats. Further, this preferred embodiment of the Program includes standard ASCII extracts for exporting access management data to other systems and also includes built-in data conversion tools, well known in the art, for a wide range of database formats including Oracle, Sybase, Dbase, Foxbase, MS-Access, and other ODBC compliant formats and to provide easy access to MS Exchange, facsimile, electronic mail, MSN, and the Internet. It will be understood by those skilled in the art that each or all of these various features are optional and depend strictly upon the application of the Program.

The Program is a client-server system for maintaining, controlling, and accessing all assets, e.g. equipment, components, and material, within an organization or enterprise. The Program contains repositories that store individual asset information or data, on a line item basis, the asset information including active, surplus, sales, contacts, lease/rental/consignment equipment, Return Material Authorization (RMA), invoice, and purchase order categories. Using the information from the repositories, the Program is capable of managing inventory, warehousing, sales, property location/removal, surplus, and lease rental operations. Essentially, an end-to-end solution is provided for complete asset management. The Program is capable of standalone operation with a local data storage unit (as in a single large company), as an enterprise configuration using a central data storage unit serving remote-client versions, and globally as an Internet based data storage unit serving clients using standard web browsers. The data storage unit, including the repositories, are standard Open Database Connectivity (ODBC) allowing data to be imported or exported to a wide variety of Structured Query Language (SQL) data base formats.

Referring specifically to FIG. 1, a Program user 10 logs onto the Program establishing an execution profile that is maintained throughout the logon session. This event is noted within the Program History repository 11 and control is routed to the System control screen 12. User 10 must enter his name and password for verification by a Security System 14. Users of the Program are required to login when the software is initially executed. The login of the user determines which functions within the Program are available for use. The highest level permits only data entry operations that are kept in an intermediate database. Users with a lower level can promote records in the intermediate database to the main database once they have reviewed the records entered. The Lowest level of user is at the administration level. This user has full access to all Program modules and can assign new users to the Program. All of the security settings are stored in a security database in an encrypted format and only the software of the Program can restructure it's original form.

Users of the Program are controlled by Security System 14, which is managed by a System Administrator, with access dependent on a user name and password logon. Using the logon information in conjunction with Security System 14, the Program provide functionality based on the user's access level assigned previously by the System Administrator. Additionally, transactions within the Program are tracked according to department or cost center to itemize operations for billing purposes. New data that is input to the Program is kept in an in-process repository and is promoted to a main repository upon approval of a user possessing cost-center/department head status or by the System Administrator, This operation permits a review process of the asset items before archiving is achieved.

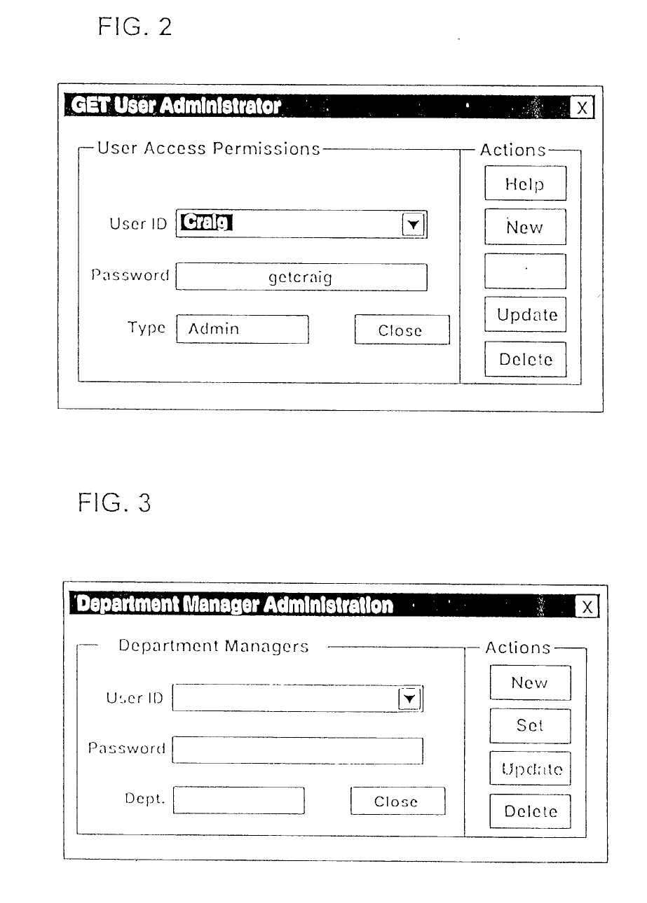

Turning in addition to FIGS. 2 and 3, two Security Configuration screens for different levels of security in the Program are illustrated. Referring specifically to FIG. 2, a security screen for a user administrator is illustrated. As explained above, a user administrator creates new users and assigns user IDs, passwords and access-levels. The window labeled ‘User ID’ in FIG. 2 is a pull-down or drop-down list of all users in the database. The window labeled ‘Password’ shows the current password for the user listed in the ‘User ID’ window. The window labeled ‘Type’ contains a list of user access levels that are selected by the user. The button labeled ‘New’ creates a new user, which is accepted as a new entry in the ‘User ID’ window. The button labeled ‘Set” is a context sensitive control which is enabled when the ‘New’ user assignment is in effect. When the button is pushed/clicked the current setting are stored in the database. The button labeled ‘Update’, when pushed/clicked overwrites existing settings within the database. The button labeled ‘Delete’ deletes an existing entry from the database.

Referring specifically to FIG. 3, a security screen for a user Department Manager Administrator is illustrated. Department manager administration works the same as the User Administration described above but manages user IDs. passwords and department assignments for manager approvals required in certain function modules. The window labeled ‘User ID’ in FIG. 2 is a pull-down or drop-down list of all department managers in the database. The window labeled ‘Password’ shows the current password for the manager listed in the ‘User ID’ window. The window labeled ‘Dept’ shows the specific department assigned to the manager in the ‘User ID’ window. The button labeled ‘New’ creates a new department manager, which is accepted as a new entry in the ‘User ID’ window. The window labeled “Set” is a context sensitive control which is enabled when the ‘New’ manager assignment is in effect. When the window is pushed/clicked the current setting are stored in the database. The window labeled ‘Update’, when pushed/clicked overwrites existing settings within the database. The window labeled ‘Delete’ deletes an existing entry from the database.

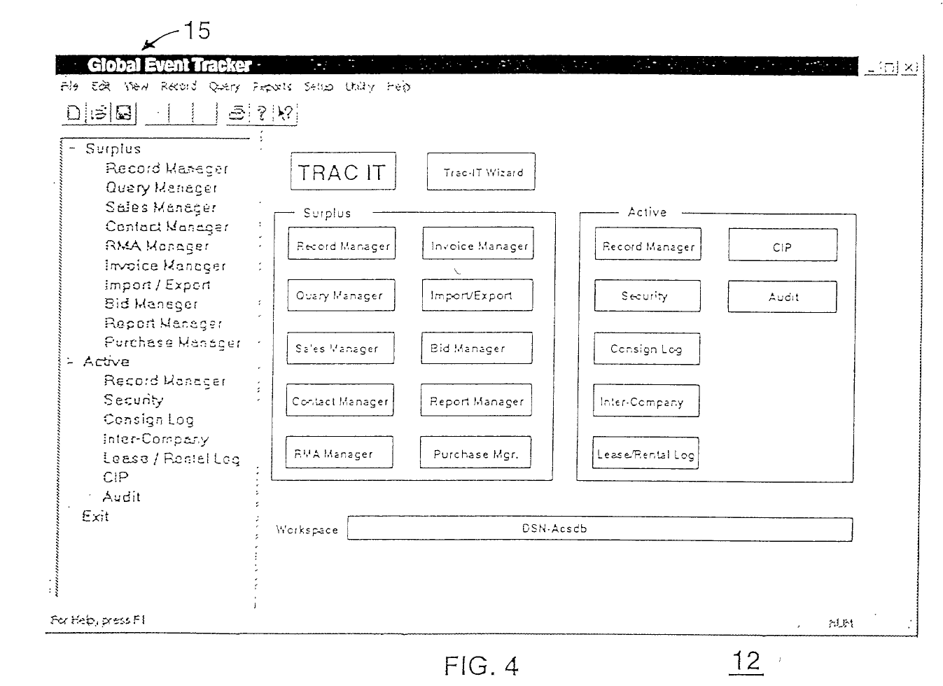

Referring in addition to FIG. 4, System control screen 12 (labeled Main Screen) for this preferred embodiment is illustrated. System control screen 12 displays a list of the various function modules and associated screens so that the user can easily select a desired function module or screen by simply pushing/clicking one of the function module windows. Also illustrated is a user definable toolbar 15 which includes, in this preferred embodiment, such functions as File, Edit, View, Record, Query, Utility, and Help as well as some of the usual self-explanatory icons. The Program includes a plurality of repositories which store information or data including active, surplus, and sales records repositories. From System Control Screen 12, user 10 can invoke operations that permit asset record entry, reporting, inventory control, sales operations, record management, and maintenance operations as needed to ensure that the repositories contain the proper information. All functions that perform operations on the repositories are recorded in a log file that provides an historical audit trail of activities by the Program. Each activity recorded is labeled by a time-stamp and activity entry in the record. Activities accumulate as separate line items under a user logon for easy trace ability.

As can be seen in screen 12 (FIG. 4), the various function modules in the Surplus Repository, including Record Manager, Query Manager, Sales Manager, Contact Manager, RMA Manager, Invoice Manager, Input/Export, Bid Manager, Report Manager, and Purchase Manager can be selected by simply clicking the appropriate window. Briefly, each of the function modules included in System control screen 12, surplus repository controls the Program to perform, or allow user 10 to perform, the following tasks.

The Record Manager (Surplus) function module enables user 10 to input and edit surplus assets by keyboard entry, barcode scan, or transfer an asset from the Active Assets or Sales repositories. Edit and update of Surplus and Sales Asset records are performed within this function module. Additionally, this module also permits user 10 to generate barcodes based on asset properties for identification purposes.

The Query Manager function module provides a table display of all assets contained within the repositories (surplus, active, sales, in-process) permitting user 10 to query for specific assets, delete assets, or transfer assets from one repository to another.

The Sales Manager function module provides a table view of the Surplus repository assets and a table view of asset records chosen to be dispositioned for sale, by user 10. Controls within the Sales Manager function module permit asset records to be sold or transferred to the Active or Surplus repositories.

The Contact Manager function module provides for the creation of contact information on a customer, user, associate, or any category containing contact information. The contact records are stored in a separate repository that is made available in all of the function modules of the Program.

The RMA Manager function module accepts various inputs for return of material from a customer/buyer. Address, shipping instructions, RMA number generation and debit memos are generated by the RMA Manager function module. The RMA function module also allows the user to view, update, or delete existing RMAs that were generated by the Program. RMA information is stored in a separate RMA repository.

The Invoice Manager function module prepares invoices for sales transactions required by the Program. Invoice generation, update, shipping information, and asset information are either input or retrieved by this module. A packing slip and invoice form are generated as output by this module. Invoice information is stored in a separate Invoice repository.

The Import/Export function module provides for the input or output of asset information from the asset repositories. This function provides for import/export of repository information to other databases or application packages. The format of the import/export information is text, either comma or tab delimited. Additionally this module is capable of generating or receiving Internet web documents, which allows for remote hosting of repository information by a web server application.

The Bid Manager function module provides for the sale of assets based on customer bids. This module permits the user to assign bids on individual assets by bidder and then selects and awards the highest bid amount on assets. Activity within this module is saved in a Bid repository for archival purposes.

The Report Manager function module generates an interface that allows user 10 to generate various reports on assets maintained within the various repositories. Templates are created during report generation and saved for future use within a Report repository.

The Purchase Manager function module provides for the creation of purchase orders required by the Program. Asset, shipping and billing information are the primary inputs that produce as output a purchase order form. Purchase orders are stored in a separate Purchase Order repository.

Also, various function modules in the Active repository, including Record Manager, Security, Consign Log, Inter-Company, Lease/Rental Log, Construction In Progress (CIP), and Audit can be selected by simply clicking the appropriate window. Briefly, each of the function modules included in System control screen 12, Active repository controls the Program to perform, or allow user 10 to perform, the following tasks.

The Record Manager (Active) function module enables user 10 to input and edit active asset records by keyboard entry, barcode scan, or by transfer from the Surplus or Sales repositories. The Record Manager function module also permits the generation of bar codes based on asset properties.

The Security function module tracks assets that have been removed or returned from a department/cost center by employee name and the security personnel approving the transaction. Checkout, return, or expire date information is stored presenting an historical record as to the status of the assets, All security records managed by this module are stored in the Security repository (designated 14 in FIG. 1).

The Consign Log function module provides for the assignment of active assets to be identified as consignment. The asset record information, date of transfer, expiration date, return date, destination address/contact, employee name, and department manager approval are stored in a Consignment repository.

The Inter-Company function module manages transfers of active assets to another department or location. The asset record information, date of transfer, expiration date, return date, destination address/contact, employee name, and department manager approval are stored in an Intercompany repository. Edit facilities are optionally included to modify intercompany assets by delete, update, transfer department and transfer to Surplus repositories.

The Lease/Rental function module provides for the generation of records that describe lease/rental transactions on Active assets. The asset record information, date of lease/rental, expiration date, return date, destination address/contact, employee name, and department manager approval are stored in a Lease/Rental repository.

The CIP (Construction in Progress) function module provides controls to manage assets by discrete projects. This module permits the coordination of assembly/lot processing and identification of the assets used in each assembled item allowing control of equipment, material, and component lots. A table display within this module provides visibility as relates to individual project costs and the project's asset records.

The Audit function module provides an auditing facility for reconciling active asset records. A table is presented of the assets contained within the Active Asset repository. User 10 selects which asset record or records he/she wishes to reconcile and selects the Reconcile (or Transfer) button or window. The Reconcile button permits a transfer of selected assets to the Surplus repository. The Reconcile function module permits user 10 to selectively assign or transfer a selected asset to a different department, add a new asset, or delete an existing asset.

Generally, each of the function modules described above includes a screen which is displayed when the appropriate button of the System select screen 12 is pushed/clicked. Several of these screens as used in this preferred embodiment are illustrated in FIGS. 5 through 13. Referring specifically to FIG. 5, a Record Manager function screen is illustrated for use in controlling the Record Manager function. A variety of windows are included which can be filled by means of keyboard entries, barcode scan or transfer of an asset. A first series of windows at the top of the screen (the top three rows) provides a complete description of the asset being viewed and includes: a ‘Quantity’ window which indicates the number of items associated with the specific asset being viewed; a ‘Type’ window which shows an identifying descriptor; an ACS# window which illustrates a unique entry for each asset entered, generally a serial number; a ‘Sold Date’ window which illustrates the date when the asset was sold as assigned by the sales manager; a ‘Serial#’ window which shows an identifying serial number assigned to the asset; a ‘Dept’ window which shows the owner of the asset; a ‘Location’ window which shows the location of the asset assigned at the initial receiving point; a ‘Receive Date’ window which shows the date the asset was received; and a ‘Description’ window which shows a general description of the asset.

Accessories accompanying the identified asset are completely identified in the next series of windows (the next four rows). An ‘Accessories’ windows permit multiple entries of accessories (sub-items) associated with the asset, by description and serial number. An area labeled ‘Includes’ provides a window for the description of additional items included with the asset and six pushbuttons allow easy insertion of common items (e.g. documents, cables, tapes, switches, terminals, cords) included with the asset. A ‘Condition window provides a description of the asset's condition when received and includes push buttons for common conditions (e.g. sealed, F/S, test, works, no test).

Sales information is included in the next series of windows (the next two rows) which include: a ‘Price’ window that is filled in by the sales manager when the item is sold; an ‘Expected Price’ window which includes a price assigned to the asset at the time the asset was received; a ‘Sold To’ window which is assigned by the sales manager when the asset is sold; a ‘Manuf, Name’ window which shows the manufacturer's name; a ‘Model#’ window which shows an identifying model number of the asset; and a ‘Contact’ window which shows a company/person to contact regarding the asset.

A series of windows is included next to the bottom of the Record Manager screen for control of the Record Manager function module. These windows include a ‘Record Navigation’ label which is associated with scroll buttons that permit user 10 to scroll to a next or a previous record in the current database. An ‘Operations; label is associated with two rows of four buttons each and allows user 10 to manage asset records. The eight control buttons include: a ‘New Record’ button which creates a new asset record in the selected database indicated by a ‘Record Type’ control button in the bottom row of the Record Manager screen; a ‘Delete Record’ button which removes an asset record from the current selected database; a ‘Search’ button which initiates a search for an asset record from the current selected data base, a pop-up window asks for a specific ACS# to locate; a ‘Save Record’ button is a context-sensitive control that is activated when a new record is in process; a ‘Repeat as New’ button prepares record manager input fields with data from the last processed asset; an ‘Update Record’ button updates changes to an existing record; a ‘View Record’ button invokes the Query Manager function module for viewing records of the selected data base in a table format; and a ‘Print Barcode’ button invokes the Barcode module for printing a barcode label for the asset.

Finally, a single row of windows in this embodiment, is included at the bottom of the Record Manager screen for control of the Record Manager function module. A window labeled ‘Record’ provides a static display showing an internally assigned record number for this asset. A ‘Record Count’ window provides a static display which shows the total record count in the selected database. A ‘Record Type’ window selects the database that the Record Manager function module performs operations on, examples of possible choices include In-Process, Main, and Sales. A final button in the lower right hand corner of the Record Manager screen is a close button for closing the Record Manager function module.

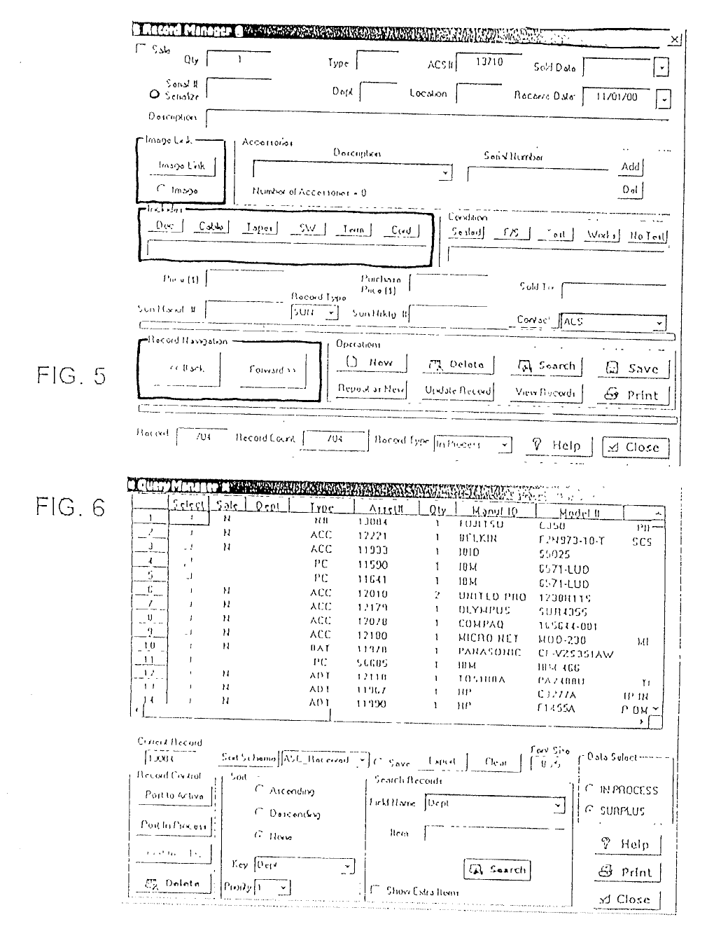

Referring specifically to FIG. 6, a Query Manager function screen is illustrated for use in controlling the Query Manager function. The Query Manager screen includes a list of asset records which is displayed in approximately the upper half of the screen. The list can be scanned or rolled up or down and left or right in a well known fashion. A ‘Sort Scheme’ window below listed assets invokes sort scheme dialog to manage sort schemes. An area labeled ‘Record Control’ contains controls that perform sort operations on the displayed records. Sort order is selected by selecting ‘Ascending, Descending, or None. A ‘Key’ window and control contains a listing of the fields that can be sorted upon. A Priority window and control allows selection of the sort order and ranges from 1 to 256.

An area labeled ‘Search Records’ contains controls to locate specific asset records in the selected database. A ‘Field Name’ window and control contains a listing of the database fields to perform the search. An ‘Item’ window displays the user value to be located. An ‘All Fields’ checkbox searches for an item in all fields in the database. A ‘Search’ button initiates the search operation.

An area labeled ‘Data Select’ contains controls to select a current database. The controls include: an ‘Active Data List’ switch which selects the Active Assets Data base; an ‘In-Process List’ switch selects the In-Process data base; a ‘Master’ Data List switch selects the Master database; and a ‘Search Data List’ switch is selected by the search operation when result data is displayed. A ‘Print’ button inputs to an associated data printer the currently displayed table. An ‘Ok’ switch closes the Query Manager function and display.

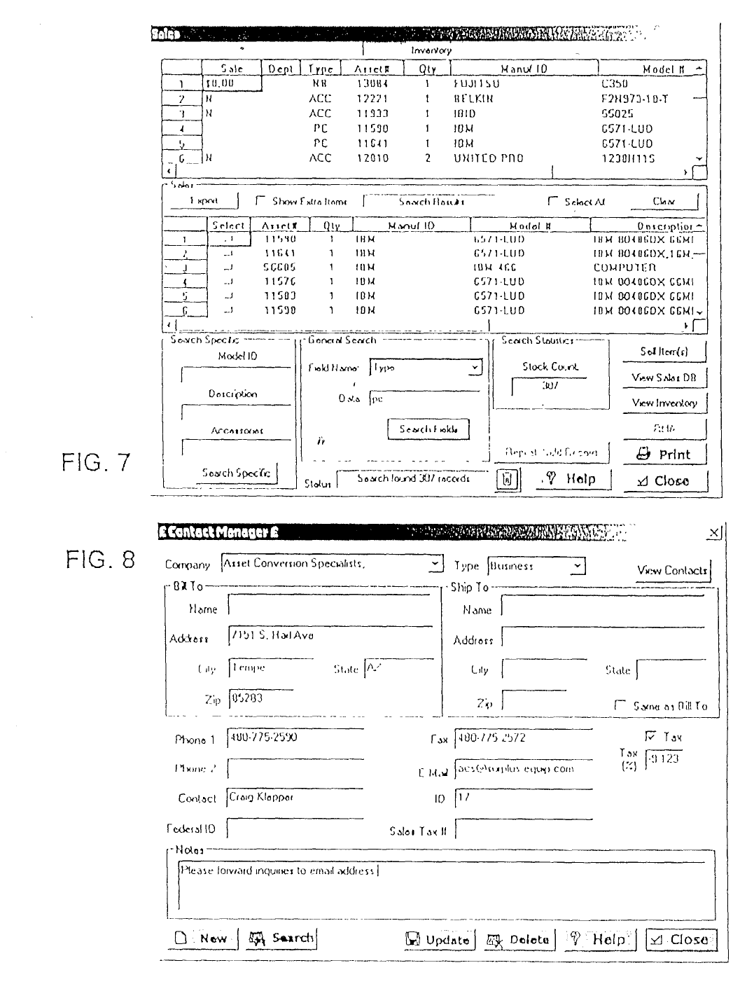

Referring specifically to FIG. 7, a Sales Manager function screen is illustrated for use in viewing and controlling the Sales Manager function. The Sales Manager screen includes a list or table of inventory asset records at the top of the screen followed by a list or table of search results which is positioned below the list of inventory asset records. Both of the lists can be scanned or rolled up or down and left or right in a well known fashion. At the bottom of the screen is an area labeled ‘Search Specific’ which contains controls to search on all fields of the selected database. A second area the right is labeled ‘General Search’ and contains controls to search on all fields of the selected database. A window and control labeled ‘Field Name’ contains a listing of all of the fields within the selected database. An area farther to the right is labeled ‘Search Statistics’ and shows the count of the search items found. This area also includes a window and control labeled ‘Report Sold Record’ which is active only when the Sales database is selected and allows transfer of selected record in the Search Results list to the Main database. A button labeled ‘Sell Item’ in the right corner processes records selected in the Search Results list to the Sales database, invokes the Invoice module for additional input and completes the sale. When the sale is successful, the record entries are transferred to the Sales database. A View Sales DB button selects the Sales database for viewing and other operations. A ‘View Inventory’ button selects the Main database for viewing and other operations. A Status button displays messages regarding the results of operations.

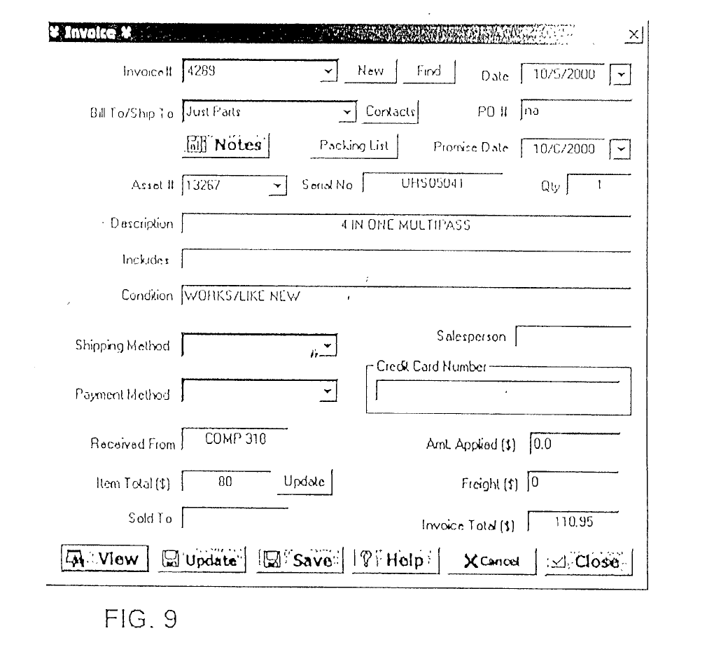

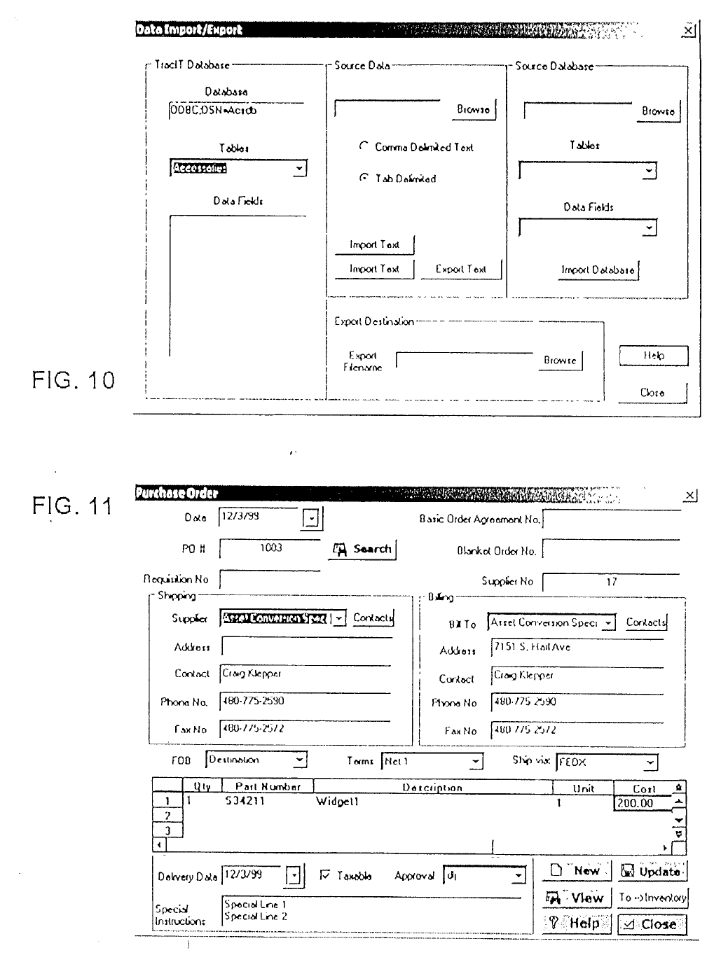

Referring to FIG. 8, a Contact Manager screen is illustrated for controlling the Contract Manager function module. Referring to FIG. 9, an Invoice Manager screen is illustrated for controlling the Invoice Manager function module. Referring to FIG. 10, a Data Import/Export screen is illustrated for controlling the Import/Export function module. Referring to FIG. 11, a Purchase Order screen is illustrated for controlling the Purchase Order function module. Each of these screens contain windows and controls for inputting or viewing information. All of these controls are believed to be self-explanatory in view of the above descriptions.

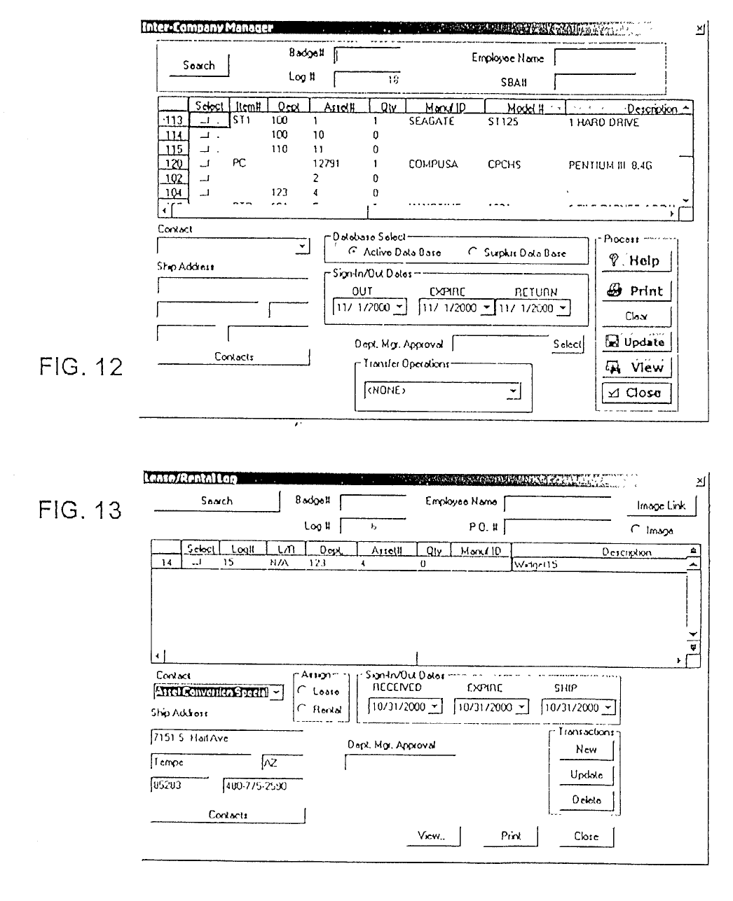

Referring specifically to FIG. 12, an Inter-Company Transfer screen is illustrated for use in performing inter-company transfers of assets. The upper portion of the screen includes a Search button which invokes a module for user input and search on the description field of a table in the central part of the screen. A Badge# window, Log# window, and Employee Name window are filled in by the employee. A P.O.# window is also a user input field for the purchase order number if applicable.

Below the centrally located table is a Contact window and control which contains a list of contacts in the Contact database. When a company/name is selected, windows below the Contact window fill accordingly with the Ship Address fields. An area labeled Data Select contains controls to select the Active or Surplus databases. An area labeled Sign-In/Out Dates contains three pop-up calendars to set the checkout, expiration, and return dates. A Dept. Mgr. Approval window immediately below these calendars includes a user input control that accepts codes generated by Department Manager Administration module. Invalid codes will not permit any operations to occur in this module. In the lower right corner a series of controls include a Transfer Dept button that invokes pop-up dialog to change the current asset's department. A Clear button clears the input control for a new input; a Delete button deletes inter-company information; an Update button updates Inter-Company data; a Print button prints the current table displayed, and a Cancel button closes the Inter-Company module.

Referring specifically to FIG. 13, a Lease/Rental screen is illustrated for use in performing Lease/Rental transfers of assets. This screen is substantially similar to the Inter-Company Transfer screen illustrated for in FIG. 12 and is used in basically the same way.

Thus, the asset maintaining, controlling and accessing program includes software instructions which control a computer with a display so that the display provides a graphical user interface. The interface includes drag and drop features, point-and-click access to user and system functions, drop-down menus, and a user definable toolbar. To use the Program user 10 must first satisfy security 14 which includes validated log-on, encrypted passwords and multiple levels of customizable security for controlling user access to sensitive data and instructions. The program includes a plurality of repositories each connected to store different asset information, which information is easily and quickly transferred between the repositories for various reasons, e.g. sales transfer, return, etc. The Program also includes software instructions for performing a plurality of user functions including receiving assets, finding asset information stored in the plurality of repositories, managing assets, and providing reports. In the preferred embodiment illustrated the software instructions for performing the receiving assets user function also includes software instructions for scanning and producing asset identifying bar codes, inputting the bar codes and vendor information, and scanning instruction and maintenance manuals. Also, in the preferred embodiment illustrated the software instructions for performing the managing assets user function includes controlling real time property logistics, storing and retrieving asset status, storing and retrieving asset transfers and assignments, and providing maintenance reminders.

While a specific embodiment has been illustrated and described, it will be understood by those skilled in the art that many of the functions and operations can be changed, modified, or eliminated for specific applications. Also, individual steps in the specific programming and software instructions are standard well known steps designed to operate with the various Windows Programs detailed above and will not, therefore, be elaborated upon herein.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An asset maintaining, controlling and accessing program comprising:
software instructions for controlling a computer with a display to provide a user interface;
a first repository and a second repository each connected to store different asset information; and
software instructions for performing a plurality of user functions including transferring assets from the first repository to the second repository.

2. An asset maintaining, controlling and accessing program as claimed in claim 1 wherein the software instructions for controlling the computer with the display to provide a user interface include drag and drop features, point-and-click access to user and system functions, and drop-down menus.

3. An asset maintaining, controlling and accessing program as claimed in claim 1 including in addition validated log-on, encrypted passwords and multiple levels of customizable security for controlling user access to sensitive data and instructions.

4. An asset maintaining, controlling and accessing program as claimed in claim 1 including in addition software instructions for performing a plurality of user functions including receiving assets, finding asset information stored in the plurality of repositories, managing assets, and providing reports.

5. An asset maintaining, controlling and accessing program comprising:
software instructions for controlling a computer with a display to provide a graphical user interface including drag and drop features, point-and-click access to user and system functions, drop-down menus, and a user definable toolbar;
validated log-on, encrypted passwords and multiple levels of customizable security for controlling user access to sensitive data and instructions;
a plurality of repositories each connected to store different asset information;
software instructions for performing a plurality of user functions including receiving assets, finding asset information stored in the plurality of repositories, managing assets, and providing reports; and
the program controlling the computer display to provide selected information stored in the plurality of repositories to a user.

6. An asset maintaining, controlling and accessing program as claimed in claim 5 wherein the software instructions for performing the receiving assets user function includes software instructions for scanning and producing asset identifying bar codes, inputting the bar codes and vendor information, and scanning instruction and maintenance manuals.

7. An asset maintaining, controlling and accessing program as claimed in claim 5 wherein the software instructions for performing the managing assets user function includes controlling real time property logistics, storing and retrieving asset status, storing and retrieving asset transfers and assignments, and providing maintenance reminders.

8. An asset maintaining, controlling and accessing program as claimed in claim 5 wherein the plurality of repositories store individual asset information on a line item basis.

9. An asset maintaining, controlling and accessing program as claimed in claim 8 wherein the plurality of repositories include asset type, number or lot, physical position, lease rental information, and depreciation information.

10. An asset maintaining, controlling and accessing program as claimed in claim 8 wherein the plurality of repositories store information including active, surplus, and sales records.

11. A method of maintaining, controlling and accessing assets comprising the steps of:
providing software instructions for controlling a computer with a display to provide a user interface;
providing a first repository and a second repository each connected to store different asset information;
storing asset information in the first repository using the display; and
using the display, shifting the stored asset information from the first repository to the second repository.

12. A method of maintaining, controlling and accessing assets as claimed in claim 8 wherein the step of providing software instructions for controlling the computer with the display includes drag and drop features, point-and-click access to user and system functions, and drop-down menus.

13. A method of maintaining, controlling and accessing assets as claimed in claim 8 including in addition a step of validating log-on with encrypted passwords and multiple levels of customizable security which controls user access to sensitive data and instructions stored in the computer.

14. A method of maintaining, controlling and accessing assets as claimed in claim 8 wherein the step of shifting the stored asset information includes selecting the first repository;
controlling the computer display to provide selected asset information stored in the first repository;
viewing the selected asset information stored in the first repository; and
transferring the selected asset information from the first repository to the second repository.

15. A method of maintaining, controlling and accessing assets comprising the steps of:
providing software instructions for controlling a computer with a display to provide a graphical user interface including drag and drop features, point-and-click access to user and system functions, and drop-down menus;
validating log-on with encrypted passwords and multiple levels of customizable security which controls user access to sensitive data and instructions stored in the computer;
providing a plurality of repositories each connected to store different asset information;
providing software instructions for performing a plurality of user functions including transferring assets from one of the plurality of repositories to another of the plurality of repositories;
selecting a first repository of the plurality of repositories;
controlling the computer display to provide selected asset information stored in the first repository of the plurality of repositories;
viewing the selected asset information stored in the first repository; and
transferring the selected asset information from the first repository to a second repository of the plurality of repositories;

16. A method of maintaining, controlling and accessing assets as claimed in claim 15 wherein the first repository is a Surplus repository and the second repository is an active repository.

17. A method of maintaining, controlling and accessing assets as claimed in claim 15 wherein the step of providing software instructions for performing the plurality of user functions includes receiving assets, finding asset information stored in the plurality of repositories, managing assets, and providing reports.
